(19) United States
(12) Patent Application Publication
(10) Pub. No.: US 2015/0245698 A1
(43) Pub. Date: Sep. 3, 2015

(54) ASSEMBLABLE COSMETIC APPLICATOR

(71) Applicant: L'OREAL, Paris (FR)

(72) Inventor: Soraya Kadra, Asnieres Sur Seine (FR)

(21) Appl. No.: 14/413,693

(22) PCT Filed: Jul. 5, 2013
(86) PCT No.: PCT/EP2013/064281

§ 371 Date: Jan. 8, 2015

Related U.S. Application Data
(60) Provisional application No. 61/681,788, filed on Aug. 10, 2012.

(30) Foreign Application Priority Data
Jul. 9, 2012 (FR) 1256600

(51) Int. Cl. A45D 40/26; A61H 7/00; A47K 7/04

(52) U.S. Cl. CPC A45D 40/26; A47K 7/04; A61H 7/003

(57) ABSTRACT

The present invention relates to a set for installing a cosmetic applicator comprising:—at least one first portion of applicator,—at least two second portions of applicator,—reversible assembly means for assembling each first portion with each second portion, in order to produce the applicator.

The subject of the present invention is a cosmetic applicator to be put together yourself, in particular for massaging and for applying a cosmetic composition, including a care composition, to a surface of the body.

In particular, this applicator is particularly advantageous in the field of massaging certain zones of the body and of cleaning the skin, and in particular in deep cleansing for removing impurities from the pores of the skin. It may also be useful in applications for cleansing or for care of the body.

The expression “cosmetic product” is understood to mean a product as defined in Council Directive 93/35/EEC of 14 Jun. 1993.

The application of a cosmetic composition with the aid of a device provided with a rotary applicator is known for example from FR 2 918 545 or U.S. Pat. No. 7,469,703.

The document US 2005/0278876 describes a device comprising a brush applicator. This brush is divided into two coaxial concentric parts that are connected together. One part is in the form of a disk, the other in the form of a ring. One part is fixed, the other is made to oscillate. The device is used for caring for the face, specifically for treating acne or imperfections or else for peeling or for shaving. It may also be used for caring for the feet or the scalp.

The document U.S. Pat. No. 7,320,691 describes a device that is also useful for the treatment of acne. This device comprises an applicator formed from two coaxial parts. One part is fixed, the other is made to carry out a percussive movement on the surface treated. The two parts are connected together.

The document EP 744 139 discloses a domestic or household device, for example a toothbrush, a massaging device or a nailcare accessory. This device comprises an applicator formed from at least two coaxial and inseparable parts. The two parts can carry out an independent rotational movement with respect to one another. For example, one part rotates in the clockwise direction. The other part rotates in the counterclockwise direction. This other part can also rotate in the clockwise direction.

The device according to U.S. Pat. No. 7,320,691 or EP 744 139 has the advantage of providing alone two independent movements that each act on the treated surface of the body. However, the applicator according to these documents is provided to the user without the latter being able to modify it in order to adapt it to his own skin. The two parts carrying out a relative movement with respect to one another are connected together and linked in a non-reversible manner.

Users have a number of problems and a number of expectations as far as the applicator is concerned. Currently, one drawback is that they have to buy a number of different applicators and use them successively, this being costly. In addition, they do not have the possibility of changing the applicator in terms of its composition and shape. It is sometimes possible for a consumer not to find a “ready to use” applicator suitable for him.

Another problem addressed by the invention is that of being able to adapt the applicator to the different contours of the face, maintaining the essence of its structure.

To this end, the invention proposes applicators to be put together in a “pick and choose” manner by the user. He puts his applicator together himself. Thus, he can choose the various components of the applicator (in portions), for example one portion having a brush and another having spikes. He selects them depending on their action on the skin in the area of the body in question. In this way, he can create a specific applicator that is specifically suitable to him at a given time.

The object of the invention is to solve all or some of the problems identified above by proposing a set for the assembly of a cosmetic applicator comprising:
at least one first portion of applicator,
at least two second portions of applicator,
reversible assembly means for assembling each first portion with each second portion, in order to produce the applicator.

Thus, rather than having only a choice between a number of “ready to use” applicators, the user can now put her applicator together herself, on the basis of applicator portions which she chooses herself.

The first portion is advantageously intended for a first cosmetic action.

The second portion is advantageously intended for a second cosmetic action.

The first and second cosmetic actions may be the same or different.

According to the invention, the use of an applicator made up of a number of portions is proposed:
It being possible for each of the portions making up the applicator to be composed of a variety of materials,
It being possible for each of the portions making up the applicator to have a variety of shapes/protuberances or the like and a variety of levels of stiffness,
It being possible for each of the portions to have different overall shapes,
It being possible for the user to choose the composition depending on the desired result.

With such an applicator having removable portions, the user can choose to take off one portion for certain sensitive areas of the face (sides of the nose) and reattach the same portions for more resistant areas (cheeks).

The invention also relates to an assembly for installing an application device comprising:
a body configured to receive an applicator,
a driving means for moving the applicator relative to the body, characterized in that it also comprises a set for installing the applicator as defined above, in order to produce the application device.

The invention also relates to a method for assembling an applicator comprising:
providing a set as defined above,
choosing at least one first portion of applicator and one second portion of applicator,
assembling the first chosen portion with the second chosen portion in order to produce the applicator.

The invention also relates to a method for installing an application device comprising:
providing a set as defined above,
choosing at least one first portion of applicator and one second portion of applicator,
assembling the first chosen portion with the second chosen portion in order to produce the applicator.
installing the produced applicator on a device configured to receive it.

Advantageously, the portions of which the applicator is made are disposed in a concentric manner. This arrangement is simple, easy to produce and adaptable to a variety of shapes.

Even more advantageously, the portions have complementary shapes in order to form an applicator. Thus, the applicator is simple for the user to produce. For example, if she knows that the applicator is in the form of a disk, she will easily understand how to position the angular portions.

Cosmetic Action

According to the invention, the cosmetic action is in particular:
A caring action,
A washing action,
A skin purification action,
An exfoliating action,
A desquamation action,
A massaging action,
A thinning action,
A makeup application action,
A makeup removal action,
A cleaning action, or
A bleaching action.

The user can choose to build an applicator in order to promote one of the actions listed above. She can also produce an applicator which combines two actions.

A number of characteristics of the applicator should be taken into consideration to obtain a desired effect. One very important aspect to be taken into account in this choice relates to the nature of the applicator.

Nature of the Applicator

Depending on the cosmetic treatment chosen, the user will build his own applicator by choosing:

1/ the Level of Rigidity
abrasive and rigid assemblies are favorable for a vigorous massage and exfoliation,
flexible assemblies are favorable for a care application,
assemblies which have an intermediate rigidity and are composed for example of bristles are favorable for cleaning

2/ the Shape of the Elements of which the Applicator is Made

He will select:
shapes with little protuberance and little relief for greater softness,
shapes with strong protuberances and strong reliefs for massaging,
shapes which are favorable for acting on the texture of the formulation, such as shapes that promote foaming (sponges with large cells) or conversely that disrupt the foam (dense sponges having small cells).

The following table illustrates examples of the nature of applicators depending on the cosmetic action desired by the person, depending on the area of the body in question.

| Nature of the | | Actions and area |
|---|---|---|
| applicators | Examples | of application |
| Abrasive applicator | Hydrophilic crosslinked polyester foam | Desquamation/ |
| (rigid foam, hard | having a density of 32 kg/m³, | keratolytic: oily |
| bristles, pumice | | skin - face; pores; |
| stone, etc.) | | radiance |
| Flexible foam | Brush having Nylon ® 6.12 bristles | Purification, |
| applicator having | diameter 0.075 mm | gentle cleaning; |
| large cells | | pores |
| Brush having | | |
| flexible bristles | | |
| Massaging | Thermocompressed polyethylene foam | Slimming - body |
| applicator having | having a density of 33 kg/m³, | |
| pronounced | complexed with Lycra ® | |
| protuberances and | Applicator having reliefs made of | |
| high rigidity | elastomer | |
| | Applicator having mobile elements | |
| Abrasive foam | Yukilon ® made of NBR | Antiwrinkle |
| applicator | | Desquamation- |
| | | radiance |
| Sponge applicator | Hydrophilic crosslinked polyester foam | Makeup removal |
| | having a density of 32 kg/m³, | Makeup |
| | Yukilon ® made of NBR | application |
| Brush applicator | Brush having Nylon ® 6.12 bristles | Body - cleaning |
| | diameter 0.075 mm | or washing |
| Foam applicator | Yukilon ® made of NBR | Cleansing of |
| | Thermocompressed polyethylene foam | pores over large |
| | having a density of 33 kg/m³, | areas, e.g. back |
| | complexed with Lycra ® | Exfoliation of |
| | Hydrophilic crosslinked polyester foam | large surfaces |
| | having a density of 32 kg/m³, | |
| Foam applicator | Yukilon ® made of NBR | Face or body |
| | Hydrophilic crosslinked polyester foam | Hydrating care |
| | having a density of 32 kg/m³, | Eye contour care |
| | | Bleaching action |
| Dense and | Foam made of crosslinked elastomer | Face and body: |
| impermeable small | | care applicator |
| cell foam applicator | | |

3/ the Materials of which the Applicator Portions are Made

These materials are themselves known to a person skilled in the art. The various constituents of the applicator may be:
Bristled fibers (nylon etc.) having different diameters
Spikes having various shapes and made of thermoplastic elastomer material (round, polygonal section)
Balls, hemispheres, waves or other massaging reliefs made of thermoplastic elastomer material
Balls, waves or other massaging reliefs made of rigid material (metal, plastics material, ceramic)
Sponge, foam or some other porous material
Roll-on having a plastics, metal or ceramic ball.

The Overall Shape and Relative Arrangement of the Various Portions

The set according to the invention can leave the choice of relative position of the portions up to the consumer, in order to have access to more varieties of effects.

Advantageously, the overall shape of the assembled applicator is concave or becomes concave during use. It may become concave if the internal part is composed of a flexible foam which shrinks in contact with the formulation. This concave overall shape makes it possible to keep the formulation under the applicator and thus to control the distribution thereof, and also makes it possible to more easily follow the reliefs of the face and of the body.

Advantageously, this involves portions which carry variable-height elements.

Examples of Applicator Portions

The applicator portion may comprise an application member comprising a cellular material which may be elastically deformable and/or compressible. This material may be a foam. The foam may be produced from a material selected from the following list: polyurethane, polyether, polyester, polyvinyl chloride, polyethylene, EVA, latex, silicone, SIS, SEBS, silicone elastomer, latex elastomer, nitrile elastomer, butyl elastomer, Neoprene®, NBR, SBR, this list not being limiting.

The applicator portion may have a composite structure having a plurality of layers having different natures, for example a number of types of foam. The applicator portion may comprise a slot or a hole opening onto the application surface.

The applicator portion may have any shape. It may have a circular, oval or polygonal cross section, for example a triangular, square, hexagonal, etc. cross section.

The applicator may have abrasive properties. “Abrasive property” should be understood as meaning a surface which, when moved over the skin, removes at least some of the dead cells from the surface.

Such surfaces can be characterized by an abrasive power of between 0.01 and 0.03 g/cm²/min. The abrasive power corresponds to the quantity of plaster removed per minute, per square centimetre of an abrasive surface applied to a square of plaster having a thickness of 50 mm using a 135 W Black and Decker CD 400 sander, the pressure exerted on the square of plaster resulting from the weight of the sander, only the movement of which in the plane of the abrasive surface is constrained.

Such applicators are obtained either by taking a substantially rigid cellular material, or by incorporating hard grains into a flexible cellular material.

An example of an abrasive surface is a nonwoven exfoliating pad sold by 3M.

The foam may be a soft and flexible foam particularly suitable for spreading the product, sometimes also known as a sponge.

The applicator may be for example a hydrophilic crosslinked polyester foam, for example having a density equal to 32 kg/m³.

A sponge traditionally used for applying foundation, such as NBR, for example Yukilon® from Penthouse Group is also conceivable.

The applicator may be made of flexible injection-molded plastics material, for example of elastomer, and have massaging reliefs, for example spikes or balls.

The application member is for example made of an elastomer such as SEBS or silicone.

The applicator may be a thermocompressed foam. Thermocompression makes it possible to create reliefs on the surface of the foam and/or to complex it with an elastic fabric, thereby making it possible to have the flexibility of the foam but the feel of a textile more pleasant than that of plastic.

An example of a thermocompressed foam is a closed-cell foam made of polyolefin, for example thermocompressed polyethylene having a specific weight of 33 kg/m³, which is for example complexed with an elastic fabric such as for example Lycra®.

The applicator may be a file made of plastics material, metal or glass.

The applicator may be a brush made of synthetic or natural bristles, for example a bristled brush having tufts of strands of Nylon® 6.12 having a diameter of 0.075 mm, which have been milled and ground in order to make them very soft in contact with the skin of the face.

The applicator may have elements that are able to rotate, such as balls or rollers, which are smooth or have reliefs in order to massage the skin.

Application Devices

A number of types of application device can be used depending on the way in which they move. These are known to a person skilled in the art. Examples are:

a) Simple movement:
Rotary movement
Oscillating movement
Rotary movement that can be reversed by the user in order to provide a massage or upward traction of the skin
Percussive movement
Vibratory movement

b) Composite movement:
Rotary movement associated with percussion
Rotary movement associated with vibration

Once produced, the applicator can be set in rotation for example.

When the applicator is rotated by the driving means, the speed of rotation of the applicator may be for example between 150 and 400 rpm, preferably between 200 and 300.

The applicator may be rotated about a geometric rotation axis which is fixed relative to the body. As a variant, the applicator may be rotated about a geometric rotation axis which is able to move relative to the body. If necessary, the movement of the applicator may be an eccentric movement, and this can make it possible to spread a composition more regularly and with a less pronounced border between the treated region and the untreated region, this possibly being advantageous for a self-tanner for example.

The applicator may be rotated about a geometric rotation axis which forms a zero angle or non-zero angle with the longitudinal axis of the receptacle. A non-zero angle may improve ergonomics.

The applicator may be mounted removably on the application device, and this can make it possible to separate the application device in order to clean it and/or to replace it with another applicator selected depending on the treatment to be carried out.

The application device may comprise shaving or hair-removal means and/or light therapy means.

The applicator portions may comprise for example color codes or other signs which inform the user about the joining possibilities. One and the same sign or one and the same color may in particular be found on applicator portions that can be joined together.

Advantageously, at least one portion comprises means for cleaning a surface of the body. Such a portion is like a standard and useful for any consumer.

More advantageously, at least one portion comprises means for exfoliating a surface of the body. Such a portion is likewise very sought-after by consumers. It is useful for the face and the body.

Even more advantageously, at least one portion comprises means for caring for a surface of the body. Unlike makeup, this portion is a basic portion and is likewise useful for men and women.

Even more advantageously, at least one portion comprises means for massaging a surface of the body. This portion provides a pleasant sensation, a complement to the application of products.

Assembly Means

Preferably, the assembly means are suitable for snap-fitting, clipping, screwing or force-fitting each first portion with each second portion. They are simple means, known to a person skilled in the art.

According to the invention, there are a number of assembly possibilities. The assembly means may be connected to each portion. For example, a portion intended for a first cosmetic action comprises a first type of installation means such as a hook. A portion intended for a second cosmetic action comprises a second type of installation means complementary to the first type of installation means, such as a second hook complementary to the first hook.

Preferably, a first portion comprises a protuberance able to engage by snap-fitting with a complementary relief on the second portion, for example in order to form a locking means.

According to one particular embodiment, the first portion element two bosses to be engaged in each case in a complementary hollow in the second portion so as to form the assembly of the two portions.

According to another embodiment, a first portion likewise comprises an installation skirt for example provided on its internal perimeter with a thread able to engage by screwing with a complementary thread provided on the external perimeter of a neck provided in a second portion.

The assembly means may also comprise at least one complementary part such as a grille or perforated part, on which each of the chosen portions is disposed. Thus, the retention of the chosen portions in the use position may be further strengthened. For example, the user introduces the portions into the openings by pushing the portions, for example with his fingers, such that said portions pass through the opening.

The portions may be installed on this complementary part, for example by snap-fastening on the external perimeter of the orifices in the grille. The intermediate part may also have a pin for installing/removing the portions.

Installation Means

Preferably, the set also comprises means for installing the applicator on a device for massaging or for applying a cosmetic composition configured to receive it. In this case, the set is adaptable to devices known per se.

Preferably, the installation means are suitable for snap-fitting, clipping, screwing or force-fitting the applicator onto the device for massaging or applying a cosmetic composition. They are simple means, known to a person skilled in the art.

These installation means may comprise one or more points of hardness or notches. These means may be located in line with a guiding groove.

According to one characteristic, the applicator comprises at least one tab provided with a projection engaging with a protuberance on the lateral edge of the massaging or application device in order to retain the applicator relative to the device.

The invention also relates to an assembly comprising a cosmetic receptacle comprising a through-hole in which at least one first portion of applicator and one second portion of applicator as defined above is housed removably.

In particular, this receptacle may be a tube or a bottle.

The invention may be better understood on reading the following description of non-limiting implementation examples thereof, and with reference to the attached drawing, in which:

FIG. 1 schematically shows a perspective view of an example of a set according to the invention,

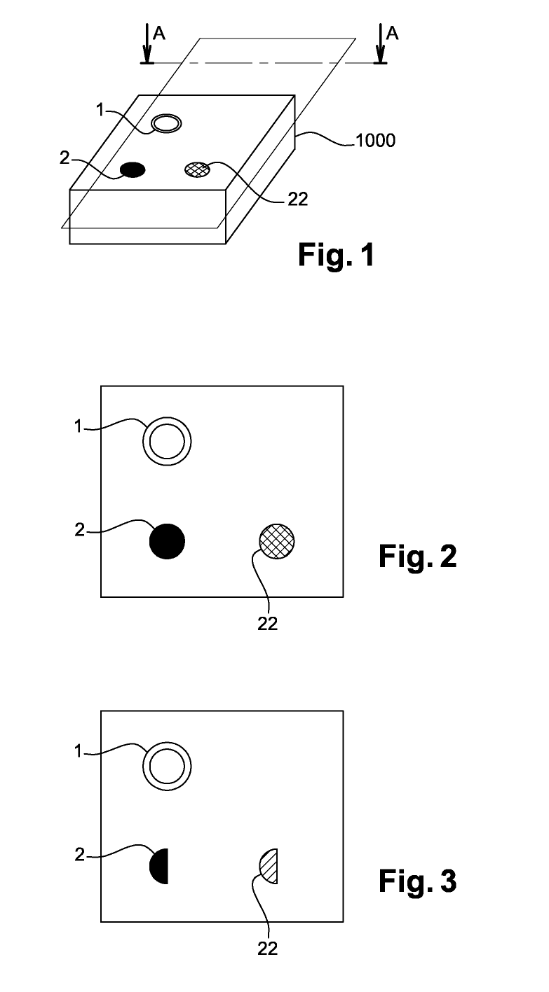

FIG. 2 shows a view from above in section AA of the set from FIG. 1.

FIGS. 3 to 7 show a view from above in section AA of a set from FIG. 1, comprising between 3 and 9 portions,

FIG. 8 schematically shows a perspective view of an example of an assembly according to the invention,

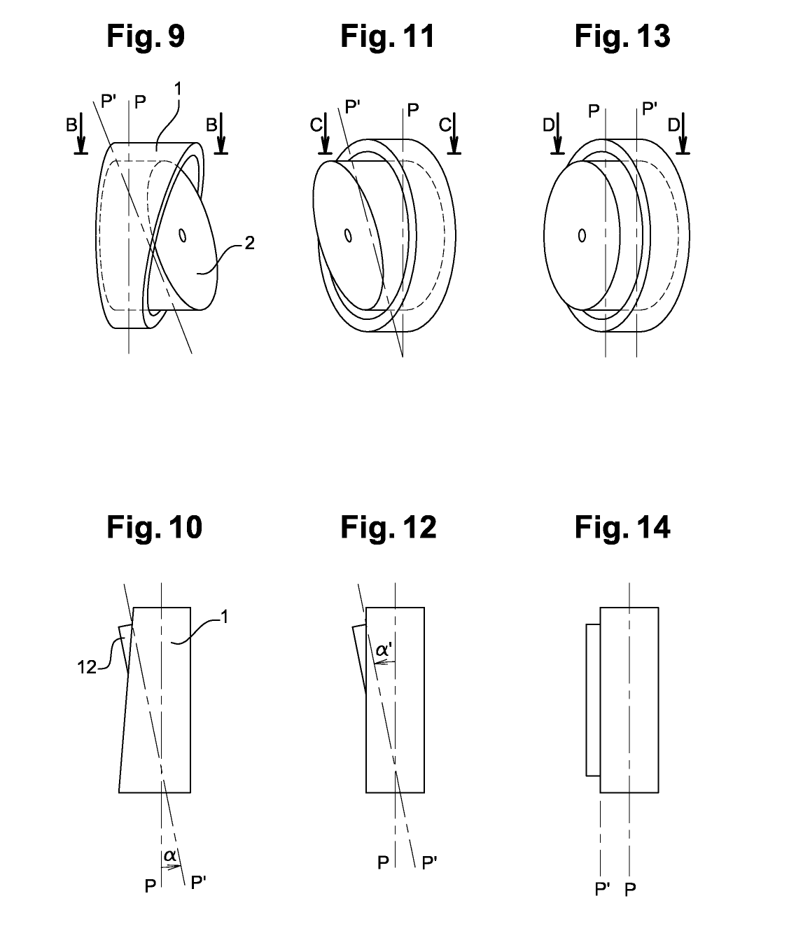

FIG. 9 schematically shows a perspective view of an applicator according to the invention with the portions in a first relative position,

FIG. 10 shows a section of the applicator from FIG. 10 in section BB,

FIG. 11 schematically shows a perspective view of an applicator according to the invention with the portions in a second relative position,

FIG. 12 shows a section of the applicator from FIG. 10 in section CC,

FIG. 13 schematically shows a perspective view of an applicator according to the invention with the portions in a third relative position,

FIG. 14 shows a section of the applicator from FIG. 10 in section DD,

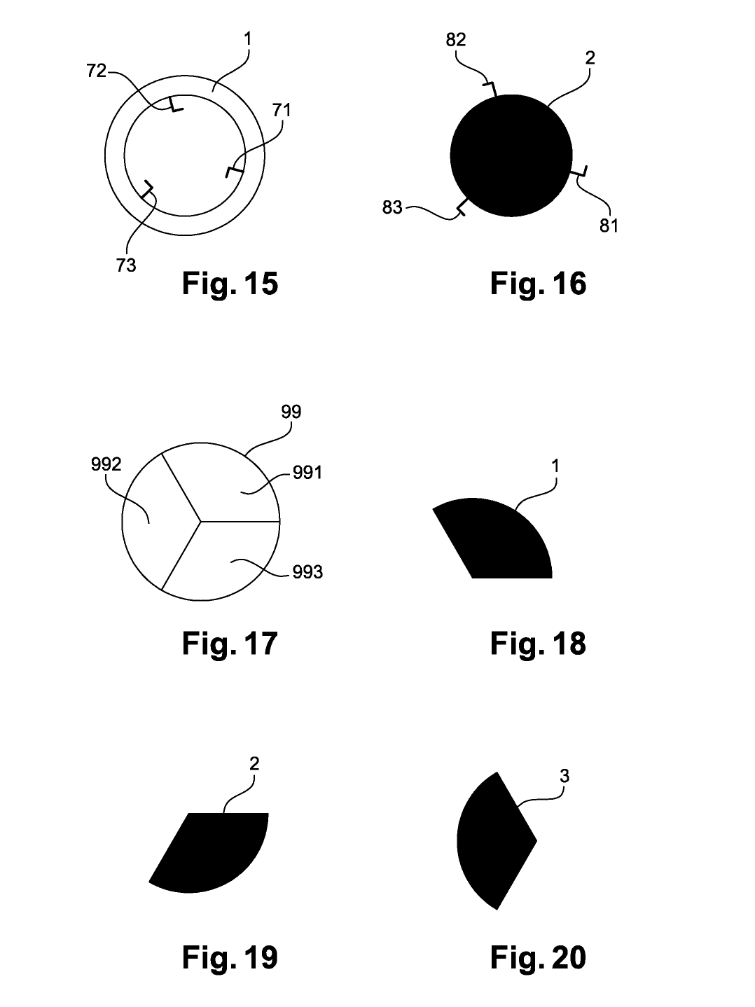

FIGS. 15 and 16 show two applicator portions and the installation means thereof formed by hooks, in section,

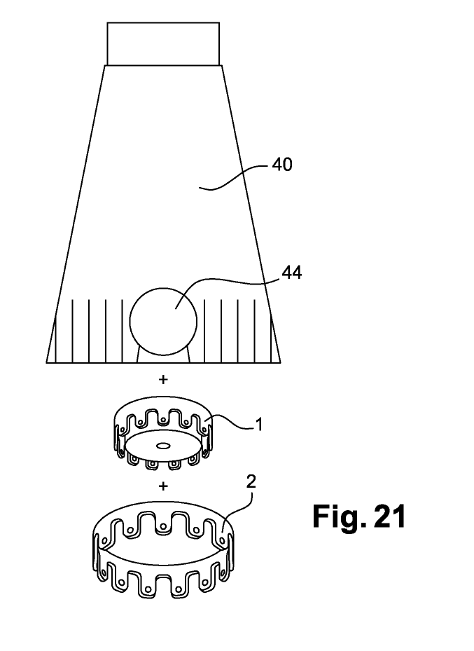

FIGS. 17 to 20 show three applicator portions and the installation means thereof formed by a grille, in section,

FIG. 21 schematically shows an example of an assembly according to the invention, in longitudinal section.

FIG. 1 shows a box 1000 comprising three applicator portions. One portion 1 is in the form of a ring. It is intended for a massaging action, but is not only intended for this purpose. By way of example, it comprises rotary balls. The two other portions 2 and 22 are in the form of disks covered with elements intended for a skin purification action. For example, these elements are spikes having a diameter of 1 mm and a height of 1 cm. The user produces the applicator by joining the ring 1 and one of the two disks 2, 22. The two disks 2, 22 may differ from one another by way of the hardness of the spikes. Depending on the sensitivity of her skin, the consumer selects the disk 2, 22 suitable for her. Each of the two discs 2, 22 may be snapped-fitted into the ring 1 by way of a simple action which does not require any force. The applicator is quick to put together. The diameter of each disk 2, 22 is provided such that they engage in the ring 1 very simply. To this end, a slight clearance is visible between the disk and the ring once they are assembled. According to this FIG. 1, the set according to the invention is packaged in a box, but this does not have to be the case. It may be a sachet for example.

FIG. 2 shows the case from FIG. 1 in section AA, in order to identify each of the applicator portions.

FIG. 3 shows another kit according to the invention in section AA. This time, the objective is to form a disk which is open at its center. To this end, the consumer is provided with a ring 1 intended for a hygiene action, and also two half disks 2, 22 intended for an exfoliating action. The disk 22 is harder than the disk 2. For example, if the consumer wishes to use the applicator for the body, she will choose to assemble 1 and 2. If she wishes to use the applicator for the face, she will choose to assemble 1 and 22. The portions may be screwed together, thereby simplifying assembly.

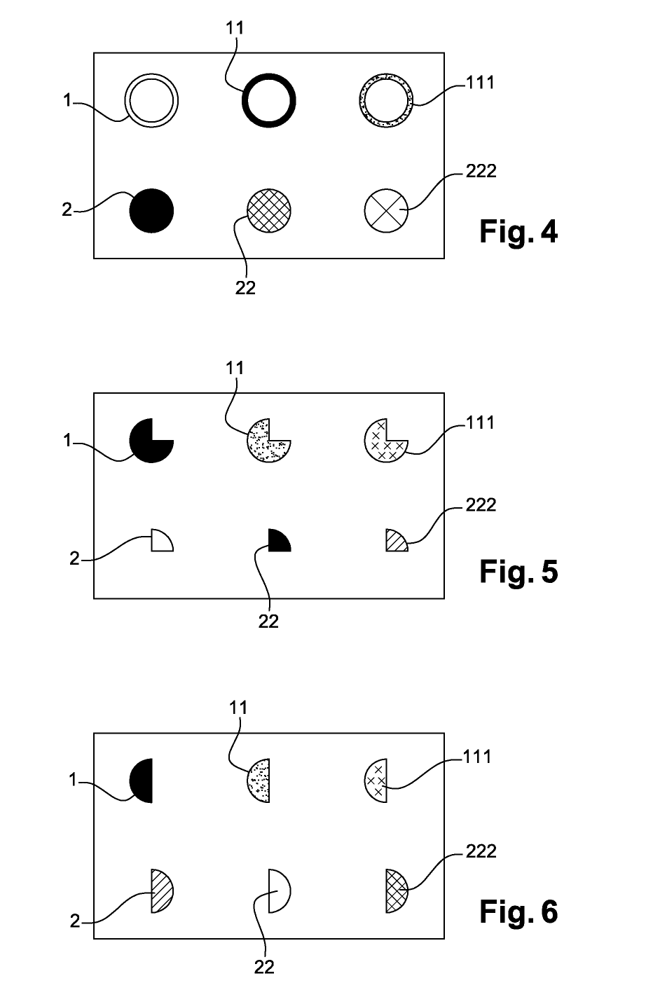

The kits shown in FIGS. 4 to 7 are formed as follows.

### FIG. 4:

Portions 1, 11, 111: rings having a cleaning action
Portions 2, 22, 222: disks having an abrasive action
Assembly means: hook
The consumer will choose a portion 1 or 11 or 111 and a portion 2 or 22 or 222 in order to form an applicator in the form of a disk.

### FIG. 5:

Portions 1, 11, 111: three-quarter disks having a cleaning action
Portions 2, 22, 222: quarter disks having a cleaning action
Assembly means: force-fitting
The consumer will choose a portion 1 or 11 or 111 and a portion 2 or 22 or 222 in order to form an applicator in the form of a disk.

### FIG. 6:

Portions 1, 11, 111: half disks having a purification action
Portions 2, 22, 222: half disks having an abrasive action
Assembly means: clipping
The consumer will choose a portion 1 or 11 or 111 and a portion 2 or 22 or 222 in order to form an applicator in the form of a disk.

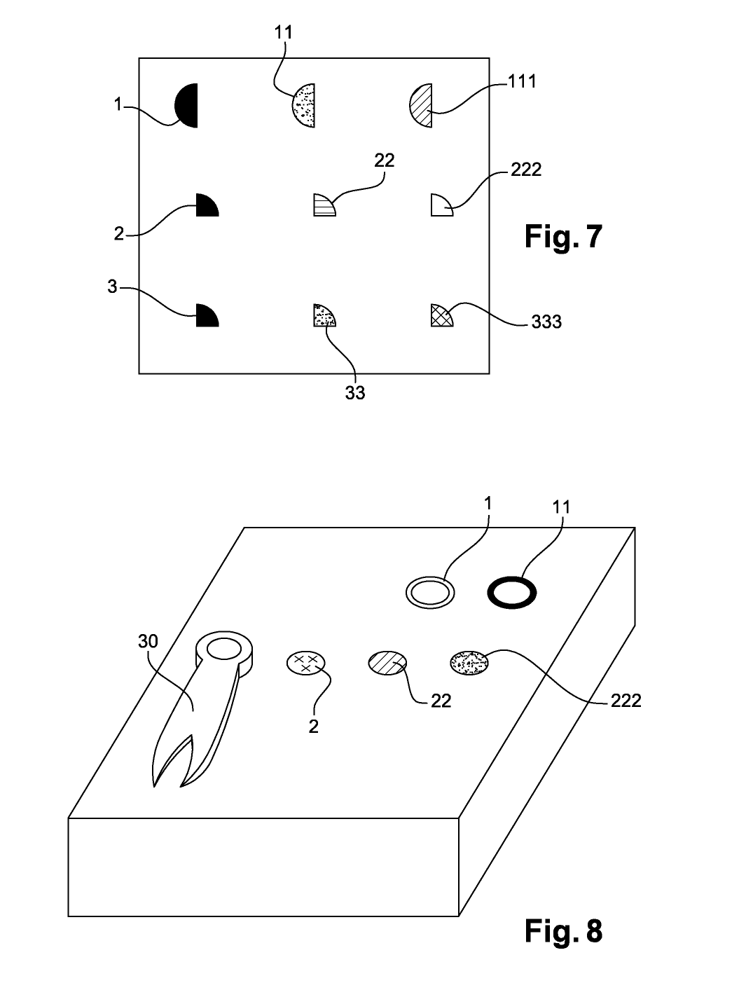

### FIG. 7:

Portions 1, 11, 111: half disks having a cleaning action
Portions 2, 22, 222: quarter disks having an abrasive action
Portions 3, 33, 333: quarter disks having a caring action
Assembly means: hook
The consumer will choose a portion 1 or 11 or 111 and a portion 2 or 22 or 222 and a portion 3 or 33 or 333 in order to form an applicator in the form of a disk.

In FIGS. 3 to 7, the applicator is in the form of a disk, but this does not have to be the case. It could have the form of a star, of a cylinder, or of a plate for example.

FIG. 8 shows an example of an assembly according to the invention. It comprises a body 30 configured to receive an applicator formed from the portions 1 or 11 and 2 or 22 or 222. For example, the portions 1 and 11 have an abrasive action. The portions 2, 22 and 222 have a softening action. These portions comprise installation hooks for installing the applicator on the body 3 in order to be driven in a rotary movement, a vibratory movement, a percussive movement or an oscillating movement.

FIGS. 9 to 14 show three possibilities of producing an applicator according to the invention with identical portions for each applicator. Simply, between each position, the angular offset between the longitudinal mid-planes of the two portions 1 and 2 varies. In FIGS. 13 and 14, the longitudinal mid-planes P and P′ of the two portions 1 and 2 are parallel. The inclination between P and P′ is zero.

In FIGS. 11 and 12, the longitudinal mid-planes P and P′ of the two portions 1 and 2 intersect. The angular offset between P and P′ is cc′, or about +20 °.

In FIGS. 9 and 10, the longitudinal mid-planes P and P′ of the two portions 1 and 2 intersect. The angular offset between P and P′ is cc′, or about −20 °.

Of course, other positions between P and P′ are possible. Depending on these positions, the areas of the body are treated differently.

FIGS. 15 and 16 show two applicator portions 1 and 2. The assembly means thereof are formed by hooks having complementary shapes. These hooks 71, 72 and 73 are disposed on the first portion. The complementary hooks 81, 82 and 83 are disposed on the second portion.

FIGS. 17 to 20 show three applicator portions and the installation means thereof formed by a grille. The grille 99 serves as a base for receiving the portions 1, 2 and 3, which are force-fitted in the orifices 991, 992 and 993.

FIG. 21 shows an assembly according to the invention comprising a cosmetic receptacle 40 in the form of a tube. It comprises a through-hole 44 in which a portion 1 and a portion 2 can be housed removably.

In order to use the device according to the invention, it is possible for example to apply a composition without the applicator being rotated, and this can make it possible for example to spread the composition over the region to be treated. The applicator is then rotated in order to massage the region to which the composition has been applied.

In another example, the applicator is rotated in order to massage the region to be treated, without a composition being dispensed.

In yet another example, the applicator is rotated in order to massage the region to be treated, without a composition being dispensed for a first time.

The massaging action may result in local heating on account of the friction of the applicator on the skin for example, and the absence of the composition on the applicator initially may increase the friction and the sensation of heat that results therefrom.

Next, while the applicator is still being rotated or, as a variant, while the applicator is at a standstill, the composition may be dispensed and spread over the region previously massaged.

The set according to the invention may also comprise at least one cosmetic product to be used with the applicator once the portions have been joined together. Advantageously, in this case the portions to be joined together may be connected to the packaging of the cosmetic product. For example, if the packaging is a tube, it may comprise at least one through-orifice, so as to reversibly house the applicator portions.

In the entire description, the expression “comprising a” should be considered as being synonymous with “comprising at least one”, unless specified to the contrary.

1.-12. (canceled)

13. A kit for the assembly of a cosmetic applicator, comprising:
at least one first portion of the cosmetic applicator;
at least two second portions of the cosmetic applicator; and
at least one reversible assembly means for assembling the at least one first portion with at least one second portion, in order to produce the cosmetic applicator.

14. The kit according to claim 13, further comprising at least one portion including means for cleansing a surface of a body.

15. The kit according to claim 13, further comprising at least one portion including means for exfoliating a surface of a body.

16. The kit according to claim 13, further comprising at least one portion including means for caring for a surface of a body.

17. The kit according to claim 13, further comprising at least one portion including means for massaging a surface of a body.

18. The kit according to claim 13, wherein the at least one reversible assembly means is configured for snap-fitting, clipping, screwing, and/or force-fitting the at least one first portion with at least one second portion.

19. The kit according to claim 13, further comprising means for installing the cosmetic applicator on a device for massaging a portion of a body and/or for applying at least one cosmetic composition to a skin, wherein the device is configured to receive the cosmetic applicator.

20. The kit according to claim 19, wherein the means for installing the cosmetic applicator is configured for snap-fitting, clipping, screwing, and/or force-fitting the cosmetic applicator onto the device for massaging the portion of the body and/or applying the at least one cosmetic composition to the skin.

21. An assembly for installing an application device, comprising:
a body configured to receive an applicator;
a driving means for moving the applicator relative to the body; and
a kit for installing the applicator on a device for massaging a portion of a body and/or for applying at least one cosmetic composition to a skin, wherein the device is configured to receive the applicator to produce the application device.

22. A method for assembling an applicator, comprising:
accessing a kit for the assembly of the applicator comprising:
at least one first portion of the applicator;
at least two second portions of the applicator; and
at least one reversible assembly means for assembling the at least one first portion with at least one second portion, in order to produce the applicator;
choosing the at least one first portion of the applicator and at least one second portion of the applicator; and
assembling the first chosen portion with the second chosen portion in order to produce the applicator.

23. A method for installing an application device, comprising:
accessing a kit comprising an applicator on a device for massaging a portion of a body and/or for applying at least one cosmetic composition to a skin, wherein the device is configured to receive the applicator;
choosing at least one first portion of the applicator and one second portion of the applicator,
assembling the first chosen portion with the second chosen portion in order to produce the applicator; and
installing the produced applicator on the device configured to receive the applicator.

24. An assembly comprising a cosmetic receptacle, the cosmetic receptacle comprising a through-hole in which at least one first portion of an applicator and at least one second portion of the applicator defined according to claim 13 are housed removably.
